(19) United States
(12) Patent Application Publication
(10) Pub. No.: US 2007/0189738 A1
(43) Pub. Date: Aug. 16, 2007

(54) Contents recorder, contents processing method, and computer readable medium storing contents processing program

(75) Inventor: Shinobu Sato, Tokyo (JP)

Correspondence Address: YOUNG & THOMPSON, 745 SOUTH 23RD STREET, 2ND FLOOR, ARLINGTON, VA, 22202, US

(73) Assignee: NEC PERSONAL PRODUCTS, TOKYO (JP)

(21) Appl. No.: 11/649,212

(22) Filed: Jan. 4, 2007

(30) Foreign Application Priority Data
Jan. 20, 2006 (JP) 2006-012397

(51) Int. Cl. H04N 5/91

(52) U.S. Cl. 386/131

(57) ABSTRACT

A contents recorder, which comprises an output unit configured to i) perform a first conversion of converting a first contents stored in a storage unit to an executable second contents and outputting the second contents, and ii) perform a second conversion of converting the first contents in the storage unit to a non-executable third contents and replacing the first contents in the storage unit with the third contents.

### BACKGROUND OF THE INVENTION

1. Field of the Invention

The present invention relates to a device for recording digital contents including, but not limited to, videos, still pictures and music. More specifically, the present invention relates to a contents recorder capable of recording data only once (CopyOnce). Example of such a contents recorder is, but not limited to, a DVD recorder, a CD recorder, a music player, an electronic book and mobile terminal capable of recording such contents.

2. Description of the Related Art

Since digital contents are not degraded in image quality when they are copied, there is the possibility that a problem with the protection of the copyright occurs if arbitrary copying operations are permitted. Relating to the problem with the protection of copyright of digital contents, various countermeasures have been proposed conventionally (refer to, for example, Japanese Patent Laid-Open No. 2002-196982 and Japanese Patent Laid-Open No. 2004-102789).

Recently, in a digital broadcast, copy control information is added to contents and distributed to protect copyright. A typical copy control technique is a CPRM (content protection for recordable media) standard applied to the DVD standard.

(content protection for recordable media) standard applied to the DVD standard.

According to the CPRM, the copy control information included in contents is checked, and it is determined whether or not the information can be recorded. To record the contents with copy control information, it is necessary to use a recorder corresponding to the copy control.

For example, when the contents (CopyOnce contents) have the copy control information indicating “recording is permitted only once (CopyOnce)”, the recorder can record the contents onto its hard disk. Once the contents are recorded on the hard disk, the copy control information of the recorded contents is changed to “no more copy is permitted (NoMoreCopy)” on the hard disk.

The contents to which the copy control information that “no copy is permitted” is added cannot be copied any more. Therefore, to record further on another storage medium such as a DVD, etc. the contents once recorded from a digital broadcast to a hard disk of a recorder, it is necessary to “move” data, but not “copy”.

“Move” is to transfer contents from an original storage medium to another storage medium, and the contents are cleared from the original storage medium. Copy-prohibited contents can be moved. For example, when the contents recorded on a hard disk from a digital broadcast are transferred to a DVD or to a mobile terminal, the contents are moved.

When HD (high definition) contents distributed by a digital broadcast are moved to a conventional DVD only corresponding to the SD (standard definition), they are down-converted to the contents of SD image quality (SD contents) corresponding to a destination recording medium. Down-conversion refers to a conversion of high-quality contents to contents of lower quality.

By down-converting contents from HD to SD (or CIF (common intermediate format)/QCIF (quarter CIF), etc.), the contents can be appreciated by another device such as a mobile terminal, etc.

As described above, when the HD contents are moved to a storage medium of SD image quality, the HD contents are down-converted into SD image quality, and can be appreciated on a mobile terminal, etc. However, in the conventional recorder, when contents are temporarily down-converted into SD contents, the contents cannot be reconstructed to the original HD image quality although the contents are moved back to the hard disk of the original recorder, and cannot be appreciated in HD image quality.

### SUMMARY OF THE INVENTION

The advantage of the present invention is to provide a recorder capable of reconstructing the high quality contents, which are down-converted and degraded in image or sound quality by moving the contents from the recorder to another recorder. Exemplary, but not limiting to, such recorder is a CD payer, a DVD recorder, a music player, an electronic book and a mobile terminal which can record contents like music, movies, videos, still pictures.

When contents recorded in an internal storage unit are down-converted and moved to another storage medium, a conventional contents recorder not only outputs the down-converted data to another storage medium, but also deletes the original contents from the storage unit to protect the copy right of the contents preventing making many copies thereof. On the contents recorder according to the present invention the contents are converted into a non-executable status and remains in the storage unit. The non-executable contents cannot be executed, played or reproduced by the recorder. So, the recorder cannot play movies, videos or music, and cannot show pictures. And the contents converted into a non-executable status cannot be reconstructed to the original executable status without data output to the other storage medium. The conversion prevents the contents from being illegally reproduced. Thus in this invention, the recorder is configured to protect the copy right of the contents.

When data, which once output to another storage medium, is moved back to the original storage unit, the contents recorder according to the present invention reconstructs the original contents. The contents recorder reconstructs the original and executable contents using the contents stored in the non-executable status in the original storage unit and the data of the down-converted contents, which is moved back to the original storage unit. When contents once degraded by a moving operation are returned to the contents recorder, the contents recorder can reconstruct the contents into the original high-quality data. Thus the recorder can play the movies or videos with original high image quality and music with original high sound quality without violating the copy right of the contents.

According to the present invention, there is provided a contents recorder which comprises an output unit configured to i) perform a first conversion of converting a first contents stored in a storage unit to an executable second contents and outputting said second contents, and ii) perform a second conversion of converting said first contents in said storage unit to a non-executable third contents and replacing said first contents in said storage unit with said third contents.

According to the present invention, there is provided a contents recording method, which comprises i) performing a first conversion of converting a first contents stored in a storage unit to an executable second contents and outputting said second contents, and ii) performing a second conversion of converting said first contents in said storage unit to a non-executable third contents and replacing said first contents in said storage unit with said third contents.

According to the present invention, a computer readable medium storing thereon a control program enabling a computer to execute the contents recording method described above.

### BRIEF DESCRIPTION OF THE DRAWINGS

FIG. 1 is a block diagram of the configuration of the contents recorder according to the first embodiment of the present invention;

FIG. 2 is a flowchart of the operation of “move” from the contents recorder to another storage medium according to the first embodiment of the present invention;

FIG. 3 is a flowchart of the operation of “move” from another storage medium to the contents recorder according to the first embodiment of the present invention;

FIG. 4A shows a drawing for explanation of the operation of “move” from the contents recorder to another storage medium according to the first embodiment of the present invention;

FIG. 4B shows a drawing for explanation of the operation of “move” from another storage medium to the contents recorder according to the first embodiment of the present invention;

FIG. 5A shows a drawing for explanation of the operation of “move” from the contents recorder to another storage medium according to the second embodiment of the present invention;

FIG. 5B shows a drawing for explanation of the operation of “move” from another storage medium to the contents recorder according to the second embodiment of the present invention;

FIG. 6 is a block diagram of the configuration of the contents recorder according to the third embodiment of the present invention;

FIG. 7A is a drawing for explanation of the operation of “move” from the contents recorder to another storage medium according to the third embodiment of the present invention;

FIG. 7B shows a drawing for explanation of the operation of “move” from another storage medium to the contents recorder according to the third embodiment of the present invention;

FIG. 8 is a block diagram of the configuration of the contents recorder according to the fourth embodiment of the present invention;

FIG. 9A is a drawing for explanation of the operation of “move” from the contents recorder to another storage medium according to the fourth embodiment of the present invention; and

FIG. 9B shows a drawing for explanation of the operation of “move” from another storage medium to the contents recorder according to the fourth embodiment of the present invention.

### DETAILED DESCRIPTION OF THE INVENTION

The embodiments of the present invention are described below in detail by referring to the attached drawings.

### First Embodiment of The Present Invention

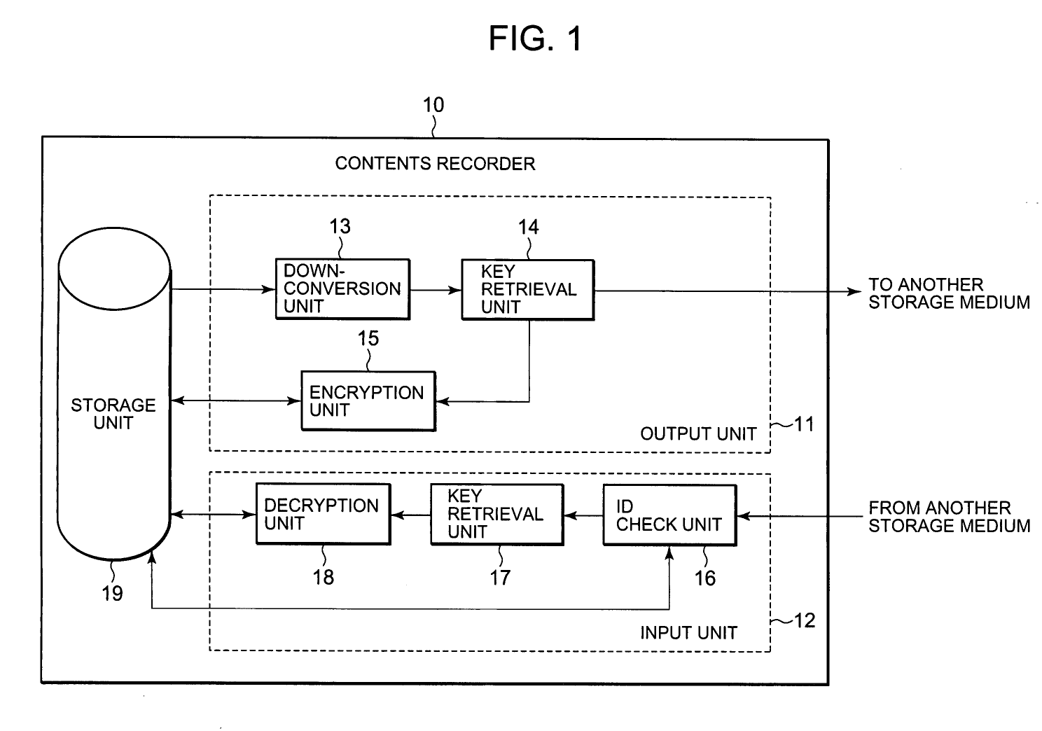

FIG. 1 is a block diagram of the configuration of the contents recorder according to the first embodiment of the present invention. With reference to FIG. 1, a contents recorder 10 includes an output unit 11, an input unit 12, and a storage unit 19. The output unit 11 includes a down-conversion unit 13, a key retrieval unit 14, and an encryption unit 15. The input unit 12 includes an ID check unit 16, a key retrieval unit 17, and a decryption unit 18.

The output unit 11 retrieves contents and their copy control information from the storage unit 19 and output the contents to another storage medium in a move operation from the storage unit 19 to the other storage medium. At this time, the output unit 11 down-converts the contents, if it is necessary in order to store the contents to the other medium. When the contents are output, the output unit 11 does not simply delete the contents from the storage unit 19, but encrypts the contents into a non-executable status to protect the copy right of the contents and leaves the encrypted contents in the storage unit 19. The output unit 11 encrypts the contents using an encryption key obtained from the down-converted contents.

In moving back the contents from the other storage medium to the storage unit 19, the input unit 12 checks the ID of the contents from the other storage medium, and confirms whether or not the contents are encrypted in the moving operation from the storage unit 19 to the other storage medium, and whether or not the data of the encrypted contents are left in the storage unit 19. If the contents have been down-converted and moved from the storage unit 19 to the other storage medium, and the encrypted contents are left in the storage unit 19, then the input unit 12 retrieves an encryption key from the contents in the other storage medium, and the encrypted contents in the storage unit 19 are decrypted using the encryption key.

In moving contents from the storage unit 19 to another storage medium, the down-conversion unit 13 in the output unit 11 retrieves contents and their control information stored in the storage unit 19 and down-converts the contents as required by the other storage medium. For example, when the contents stored in the storage unit 19 are HD contents and the other storage medium only capable of storing SD contents, the down-conversion unit 13 converts the HD contents into the contents of the SD (SD contents).

The key retrieval unit 14 retrieves an encryption key from the contents (for example, the SD contents) down-converted by the down-conversion unit 13, and provides the encryption key for the encryption unit 15. Simultaneously, the key retrieval unit 14 transmits the down-converted contents to the other storage medium. In this embodiment of the present invention, as an example, a predetermined portion of the SD contents is defined as an encryption key. The key retrieval unit 14 retrieves a predetermined portion from the SD contents input from the down-conversion unit 13, and provides the portion as an encryption key for the encryption unit 15.

It is desired that different value is used as an encryption key for different contents. Since it is common that the contents has similar header, an encryption key may include a portion other than the header. Thus, the possibility that the same encryption key is used in plural contents can be reduced. Furthermore, encryption keys can include plural portions of the contents, for example, plural portions discreet in time so that different encryption keys can be used for the contents including similar images. Thus, the possibility that the same encryption keys are used in plural contents including similar images can be reduced.

The encryption unit 15 encrypts the HD contents in the storage unit 19 using an encryption key from the key retrieval unit 14, and places the encrypted HD contents in the non-executable status.

On the other hand, the ID check unit 16 in the input unit 12 checks the ID of the contents from another storage medium in the moving operation from the other storage medium to the storage unit 19, and confirms whether or not contents are encrypted in the moving operation from the storage unit 19 and whether or not the encrypted contents are left in the storage unit 19. If there are the encrypted contents in the storage unit 19, the ID check unit 16 provides the contents from the other storage medium for the key retrieval unit 17. If there are no encrypted contents in the storage unit 19, the ID check unit 16 stores the contents from the other storage medium in the storage unit 19.

The ID checked by the ID check unit 16 is identification information for identification of contents. The file name assigned to the contents when they are stored in the storage unit 19 can be used as an ID. When the down-conversion unit 13 down-converts the contents, the unit can assign an ID additional to a file name.

The key retrieval unit 17 retrieves an encryption key from the contents output by the ID check unit 16, and provides it for the decryption unit 18. The method of retrieving a key is the same as in the key retrieval unit 14 of the output unit 11. That is, an encryption key can be a predetermined portion of down-converted contents.

The decryption unit 18 decrypts encrypted contents in the storage unit 19 using an encryption key provided from the key retrieval unit 17, and places the contents in a executable status.

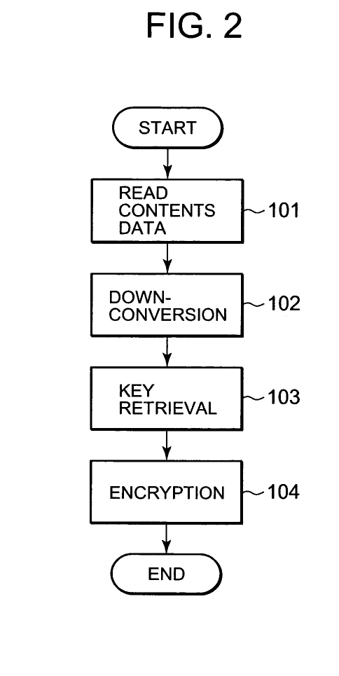

FIG. 2 is a flowchart of the operation of “move” from the contents recorder to another storage medium according to the first embodiment of the present invention. With reference to FIG. 2, the contents recorder 10 retrieves the contents specified by a user from the storage unit 19 (step 101). At this time, the contents recorder 10 does not delete data of the contents in the storage unit 19.

Next, the contents recorder 10 down-converts the contents retrieved from the storage unit 19 to the destination storage medium (step 102). Then, the contents recorder 10 retrieves an encryption key from the down-converted contents (step 103), and places the contents in the storage unit 19 in a non-executable status using the encryption key (step 104). The contents are converted to non-executable form, so the contents may remain in the recorder while protecting the copy right of the contents.

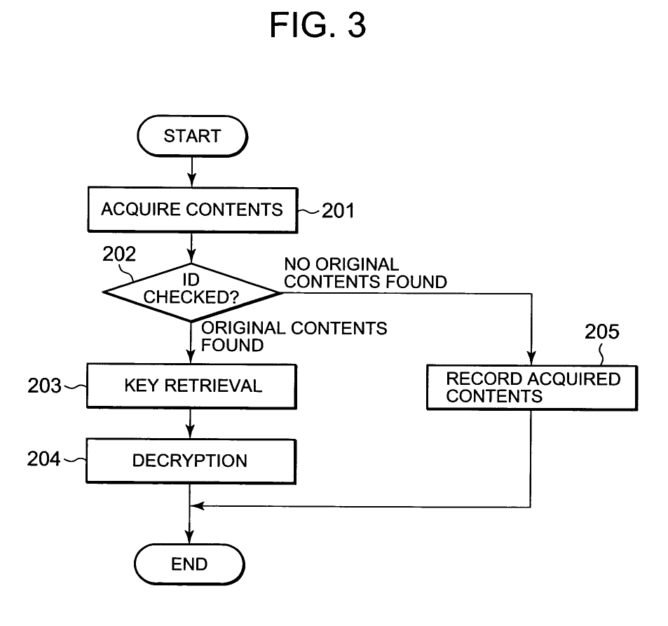

FIG. 3 is a flowchart of the operation of “move” from another storage medium to the contents recorder according to the present embodiment. The explanation below is given on the supposition that the contents to be moved to the storage unit 19 of the contents recorder 10 were previously moved to the other storage medium after down-converting the contents originally stored in the storage unit 19, and the encrypted data is left in the storage unit 19.

With reference to FIG. 3, when the contents recorder 10 acquires contents from another storage medium (step 201), it determines whether or not the encrypted contents before down-conversion is stored in the storage unit 19 (step 202).

If the encrypted data is stored in the storage unit 19, the contents recorder 10 retrieves an encryption key from the acquired contents (step 203). The contents recorder 10 decrypts the encrypted contents stored in the storage unit 19 using the encryption key (step 204).

If the storage unit 19 stores no encrypted data, the contents recorder 10 stores the acquired contents as is in the storage unit 19 (step 205).

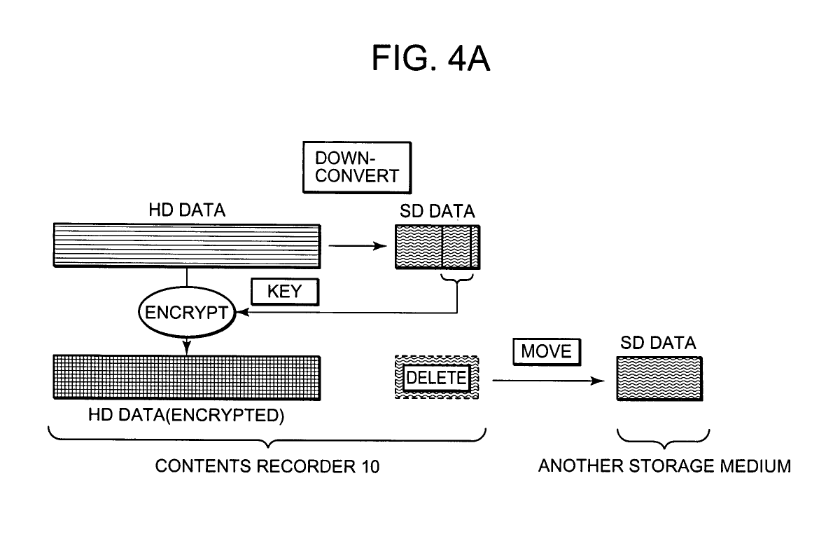

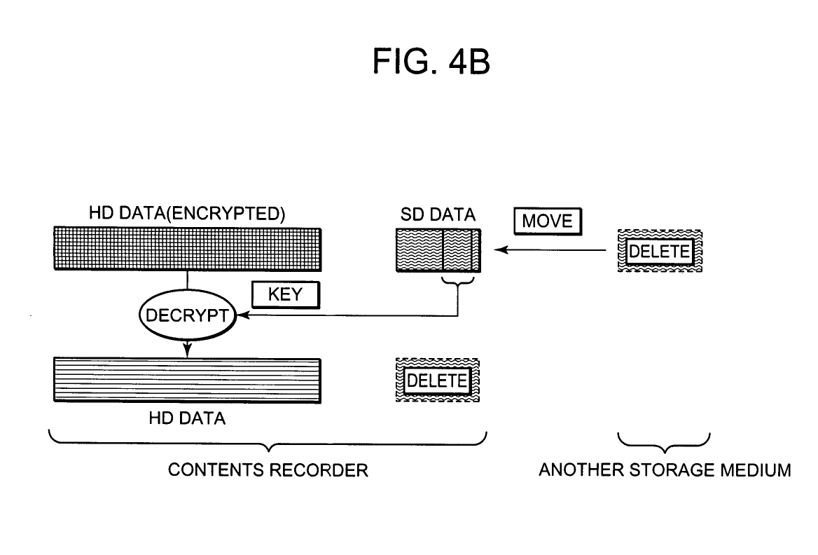

FIG. 4A shows a explanation of the operation of “move” from the contents recorder to another storage medium according to the present embodiment. With reference to FIG. 4A, the data (HD data) of the HD contents is down-converted to the data (SD data) of the SD contents. Then, an encryption key is taken from the SD data. The encryption key may be a predetermined part of, predetermined parts of or an entire portion of the SD data. The HD data is encrypted using the encryption key. A predetermined part of, predetermined parts of or an entire portion of the HD data may be encrypted. Then, the SD data is moved to the other storage medium.

FIG. 4B shows a explanation of the operation of “move” from another storage medium to the contents recorder according to the present embodiment. The contents to be moved are the contents of which encrypted data remains in the storage unit 19. With reference to FIG. 4B, when the SD data is moved from another storage medium to the contents recorder 10, the contents recorder 10 retrieves an encryption key from the SD data, and decrypts the encrypted data in the storage unit 19.

As explained above, according to the first embodiment of the present invention, in the moving operation from the contents recorder 10 to another storage medium,

1. the down-conversion unit 13 of the output unit 11 down-converts contents,

2. the key retrieval unit 14 acquires an encryption key from the down-converted data, and

3. the encryption unit 15 encrypts the data of the contents of the storage unit 19 using the encryption key to protect the copy right of the contents.

In the moving data from the other storage medium to the contents recorder 10,

1. when the ID check unit 16 of the input unit 12 checks whether or not the encrypted data of the contents from the other storage device is left in the storage unit 19, and if there is the data left, then

2. the key retrieval unit 17 retrieves an encryption key, and the decryption unit 18 decrypts the data.

Therefore, the contents recorder 10 according to the present embodiment can restore the contents to their original quality when the contents down-converted by moving the contents to another storage medium are moved back to the original contents recorder 10.

When the contents are stored in a storage medium, the data is generally encrypted by a CPRM (content protection for recordable media) technique and in a method unique to the equipment. In the present embodiment, when the storage unit 19 and another storage medium store contents, it is preferable that data is encrypted when a write is performed and decrypted when a read is performed. However, since the process is known to a person having cordially skill in the art, a detailed explanation is not discussed here. The same holds true with the subsequent embodiment of the present invention.

Additionally, in this embodiment of the present invention, a conversion from HD contents to SD contents is shown as an example of down-conversion, but the present invention is not limited to this embodiment. That is, the present invention can be widely applied to a conversion in a compression system such as a conversion from the MPEG 2 to the MPEG 4 in addition to the resolution conversion represented by a conversion from the HD contents to the SD contents. This holds true with the following modes for embodying the present invention.

### Second Embodiment of The Present Invention

In the present embodiment, a predetermined portion of SD contents is defined as an encryption key, but the present invention is not limited to this embodiment. That is, in the second embodiment of the present invention, a hash value of the data of SD contents is an encryption key. A hash value is generated by applying hash algorithm to a predetermined part, predetermined parts or an entire data of the SD contents. The present embodiment is not limited to the hash algorithm. Any algorithm which can produce a value from the SD data can be used.

The configuration of the contents recorder according to the second embodiment of the present invention is the same as the configuration according to the first embodiment shown in FIG. 1. However, in the second embodiment, the key retrieval unit 14 of the output unit 11 is different in operation from the key retrieval unit 17 of the input unit 12.

The key retrieval unit 14 according to the present embodiment obtains a hash value of the contents (for example, the SD contents) down-converted by the down-conversion unit 13, uses it as an encryption key, and provides the encryption key for the encryption unit 15. The key retrieval unit 14 simultaneously transmits the data of the down-converted contents to another storage medium.

The key retrieval unit 17 according to the present embodiment retrieves an encryption key from the contents from the ID check unit 16, and provides it for the decryption unit 18. The method of retrieving a key is the same as that of the key retrieval unit 14 of the output unit 11, and uses the hash value of the down-converted contents as an encryption key.

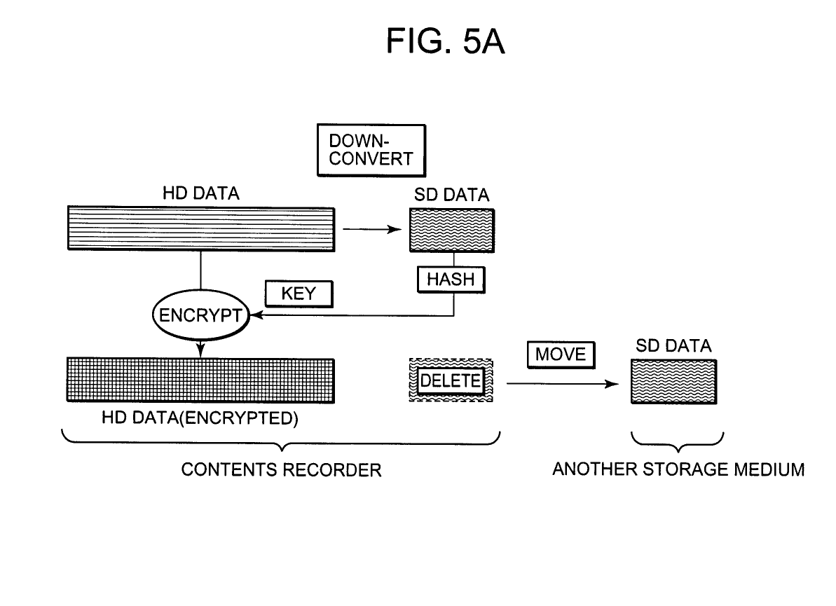

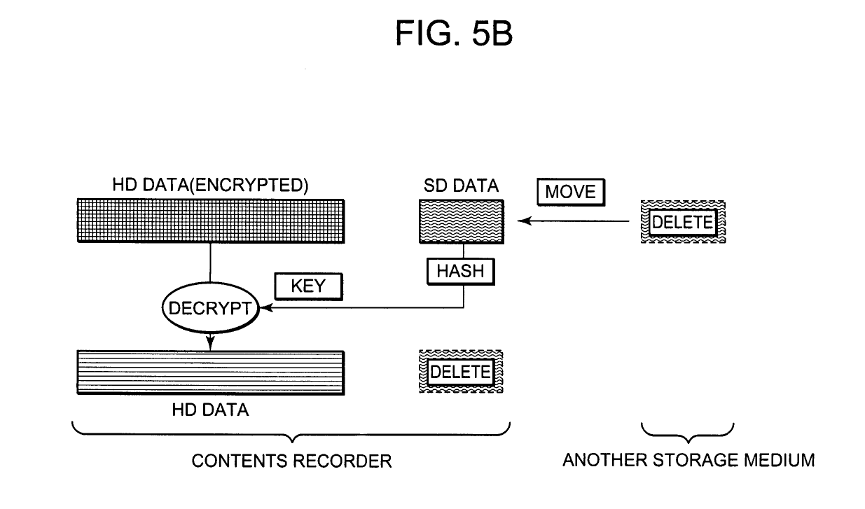

FIG. 5A shows a explanation of the operation of “move” from the contents recorder to another storage medium according to the second embodiment of the present invention. With reference to FIG. 5A, a hash value of the data of the SD contents (SD data) obtained by down-converting the data of the HD contents (HD data) is used as an encryption key. A predetermined part, predetermined parts or an entire portion of the HD data is encrypted using the encryption key. The SD data is moved to another storage medium.

FIG. 5B shows a explanation of the operation of “move” from another storage medium to the contents recorder according to the second embodiment. The contents to be moved are the contents of which encrypted data remains in the storage unit 19. With reference to FIG. 5B, when SD data is moved from another storage medium to the contents recorder 10, the contents recorder 10 obtains a hash value of the SD data, uses it as an encryption key, and decrypts the encrypted data in the storage unit 19.

As explained above, the contents recorder 10 according to the present embodiment has the same effect as in the first embodiment. That is, when the contents are down-converted by moving, output from the contents recorder to another storage medium, and moved back to the contents recorder 10, the contents recorder 10 can reconstruct the image quality of the contents to the original quality. Since a hash value is used in the present embodiment, there is a very low possibility that the same encryption keys are used in a plurality of contents. Additionally, since a hash value cannot be obtained without entire data of the down-converted contents, and the data of encrypted contents cannot be decrypted, there is the advantage that it is more difficult to decrypt the data.

### Third Embodiment of The Present Invention

In the first and second embodiments of the present invention, an encryption key is retrieved from the down-converted contents, and the contents in the storage unit 19 is encrypted using the encryption key, but the present invention is not limited to these embodiments.

In the third embodiment of the present invention, by deleting a part of the contents stored in the storage unit 19, the contents in the storage unit 19 are placed in an incomplete status in which a normal reproducing operation cannot be performed. Since a deleted portion is inserted into the data of down-converted contents, the contents in the storage unit 19 cannot be returned to a complete status without the down-converted data. To make it more difficult to reproduce data, a plurality of portions discrete in time can be deleted.

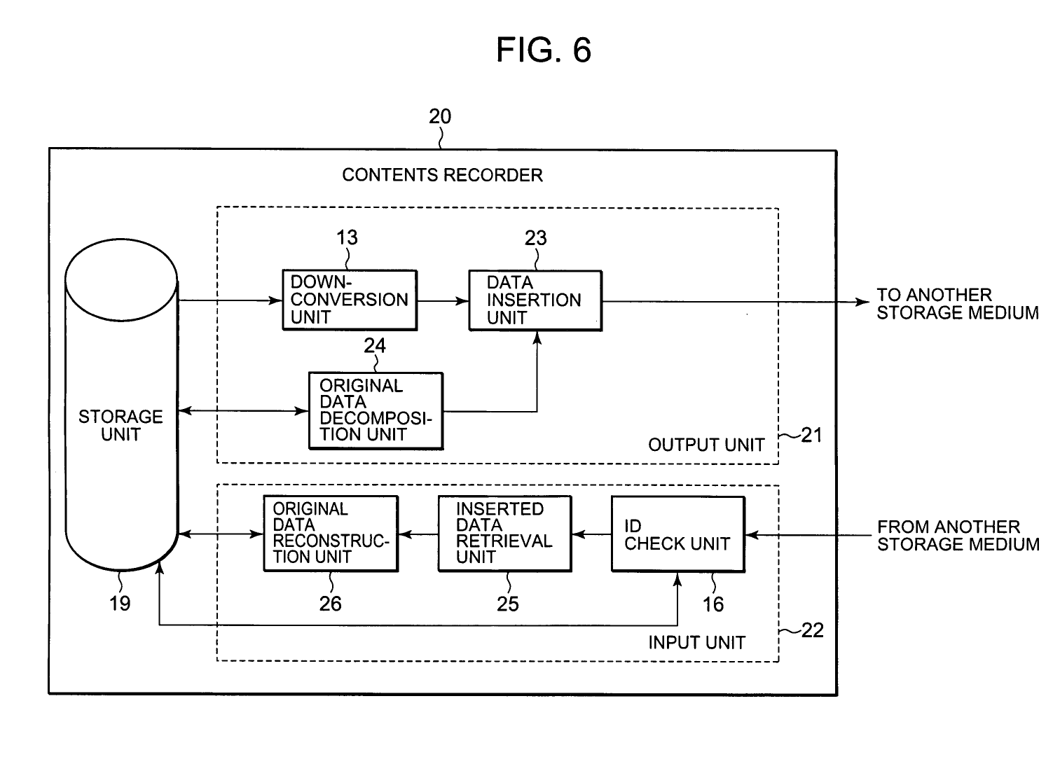

FIG. 6 is a block diagram of the configuration of the contents recorder according to the third embodiment. With reference to FIG. 6, a contents recorder 20 includes an output unit 21, an input unit 22, and a storage unit 19. The output unit 21 includes the down-conversion unit 13, a data insertion unit 23, and an original data decomposition unit 24. The input unit 22 includes the ID check unit 16, an inserted data retrieval unit 25, and an original data reconstruction unit 26.

The output unit 21 retrieves the contents and their copy control information stored in the storage unit 19 in the moving operation from the storage unit 19 to another storage medium, and outputs the contents to the other storage medium. At this time, the output unit 21 down-converts the contents, if it is necessary in order to store the contents to the other medium. When the contents are output, the output unit 21 does not delete the contents from the storage unit 19, but delete a part of the contents and places the contents in an incomplete status or non-executable status in which they cannot be normally reproduced in the storage unit 19 to protect the copy right of the contents. The deleted part is inserted into the contents outputted to the other storage medium.

The input unit 22 checks the ID of the contents from another storage medium in the moving operation from the other storage medium to the storage unit 19, and confirms whether or not there is incomplete contents generated in the moving operation from the storage unit 19 to another storage medium and the incomplete contents are left in the storage unit 19. If there are the contents moved from the storage unit 19 to another storage medium after down-conversion and left as incomplete contents in the storage unit 19, then the input unit 22 retrieves the portion inserted into the contents from another storage medium, and restores the portion to the data of the contents in the storage unit 19 and places the contents to a complete status.

The down-conversion unit 13 of the output unit 21 and the ID check unit 16 of the input unit 22 are the same as those in the first and second embodiments of the present invention.

The original data decomposition unit 24 in the output unit 21 deletes a part of data of the contents in the storage unit 19, and provides the deleted data for the data insertion unit 23. The data of contents from which a part has been deleted cannot be normally reproduced. For more difficult reproduction, a plurality of portions discrete in time can be deleted from the data of the contents of the storage unit 19.

The data insertion unit 23 inserts the data provided from the original data decomposition unit 24 into the data of the contents down-converted by the down-conversion unit 13. The insertion position is predetermined. For example, the data can be inserted into the private packet of SD contents.

On the other hand, the inserted data retrieval unit 25 in the input unit 22 retrieves the data inserted therein from the data of the contents from the ID check unit 16, and provides the data for the original data reconstruction unit 26.

The original data reconstruction unit 26 returns the data provided from the inserted data retrieval unit 25 to the data of the incomplete contents in the storage unit 19, and places it in a executable status.

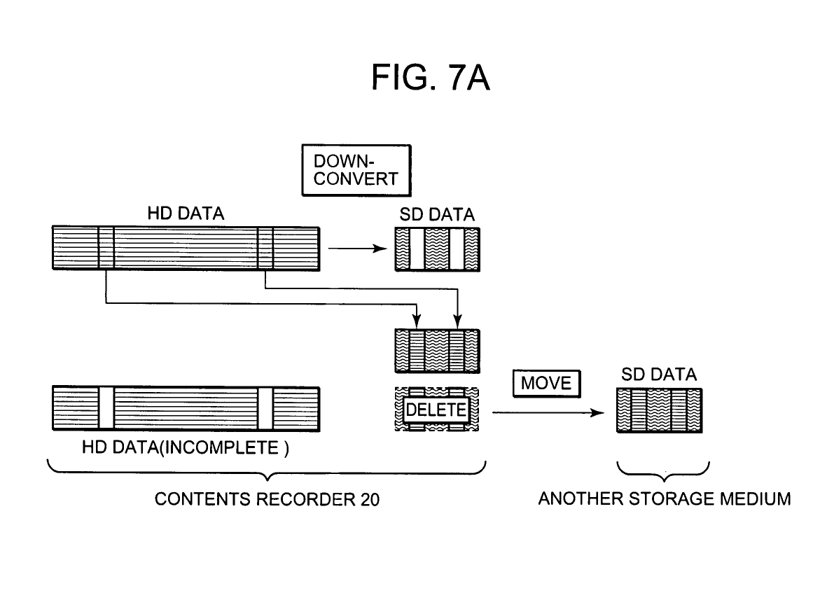

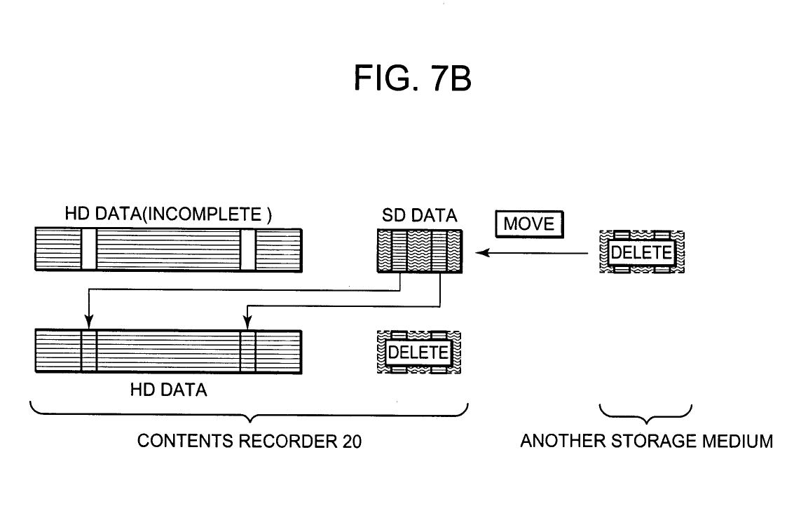

FIG. 7A gives a explanation of the operation of “move” from the contents recorder to another storage medium according to the third embodiment. With reference to FIG. 7A, a part of the HD data is deleted, and the deleted portion is inserted into the SD data obtained by down-converting the HD data. Thus, the SD data is moved to another storage medium.

FIG. 7B shows a explanation of the operation of “move” from another storage medium to the contents recorder according to the third embodiment of the present invention. The contents to be moved are the contents which remain as incomplete data in the storage unit 19. With reference to FIG. 7B, when the SD data is moved from another storage medium to the contents recorder 20, the contents recorder 20 retrieves the data inserted into the SD data, and inserts the data into the incomplete HD data in the storage unit 19, thereby reconstructing the original HD contents.

As described above, when the contents down-converted by the moving operation and output from the contents recorder 20 to another storage medium is moved back to the contents recorder 20, the contents recorder 20 can return the image quality to the original quality of the contents. Furthermore, since it is not necessary to perform complicated processes such as encryption, decryption or arithmetic operations of a hash function, etc., it can be constituted in an easy and simple configuration.

According to the present embodiment, contents are placed in a status in which they cannot be normally reproduced by deleting a part of the contents in the storage unit 19, but the method of deleting the data of the contents is arbitrarily determined. However, it is preferable that data is deleted such that contents cannot be useful as contents. It is also possible to delete a part of the contents and simultaneously encrypt the data to make it more difficult to reproduce the data.

### Fourth Embodiment of The Present Invention

According to the fourth embodiment, the contents in the storage unit 19 is encrypted using a separately generated encryption key, and the encryption key is inserted into the down-converted contents. The encryption key is inserted using, for example, an electronic watermark technique. That is, the encryption key is inserted as an electronic watermark into the down-converted contents. Since the encryption key is inserted as an electronic watermark into the down-converted contents, the contents in the storage unit 19 cannot be decrypted without the down-converted data.

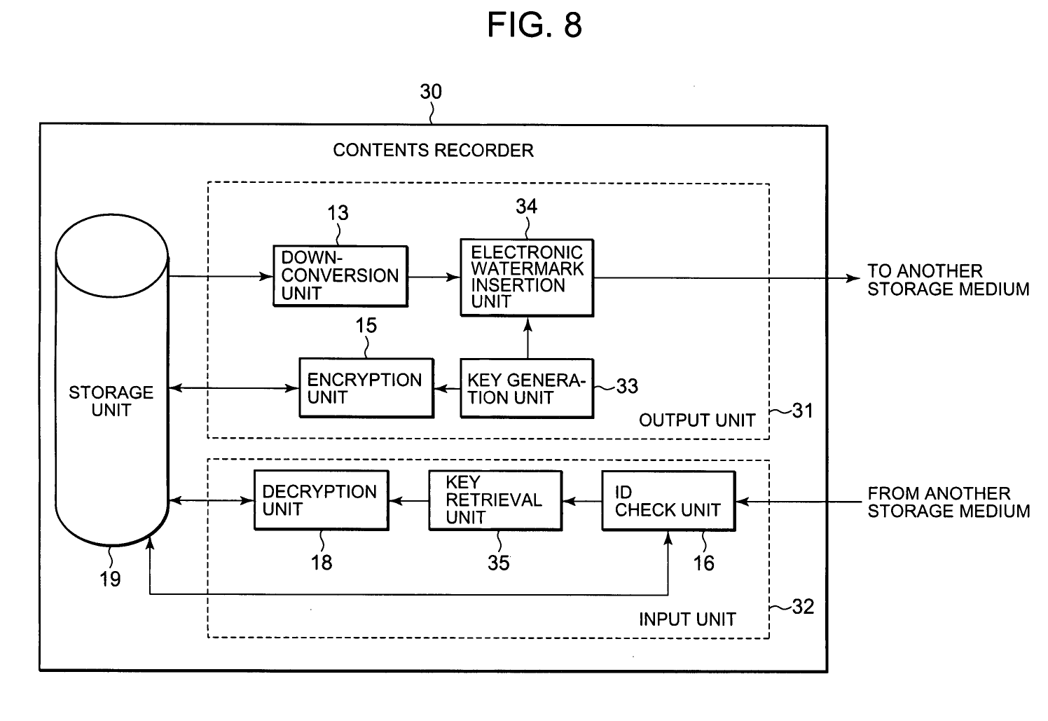

FIG. 8 is a block diagram of the configuration of the contents recorder 30 according to the fourth embodiment of the present invention. With reference to FIG. 8, a contents recorder 30 includes an output unit 31, an input unit 32, and the storage unit 19. The output unit 31 includes the down-conversion unit 13, an electronic watermark insertion unit 34, a key generation unit 33, and the encryption unit 15. The input unit 32 has the ID check unit 16, a key retrieval unit 35, and the decryption unit 18.

In moving data from the storage unit 19 to another storage medium, the output unit 31 retrieves the contents and their copy control information stored in the storage unit 19, and outputs the contents to another storage medium. At this time, the output unit 31 down-converts the contents, if it is necessary in order to store the contents to the other medium. When the output unit 31 outputs the contents, encrypts at least a part of the contents using an encryption key generated by the key generation unit 33, and leaves the encrypted contents in the storage unit 19. The output unit 31 inserts an encryption key into the down-converted contents by the electronic watermark insertion unit 34, and then outputs the data.

The input unit 32 checks the ID of the contents from another storage medium in moving data from the other storage medium to the storage unit 19, and confirms whether or not the contents are once encrypted in the moving operation from the storage unit 19 to the other storage medium and whether or not the data of the encrypted contents is left in the storage unit 19. If there are the contents moved from the storage unit 19 to the other storage medium after down-conversion and left as encrypted contents in the storage unit 19, then the input unit 32 retrieves the encryption key inserted as an electronic watermark into the contents from the other storage medium, and decrypts the contents in the storage unit 19 and places the contents in a executable status.

The down-conversion unit 13 and the encryption unit 15 of the output unit 31, and the ID check unit 16 and the decryption unit 18 of the input unit 22 are the same as those in the first embodiment of the present invention.

The key generation unit 33 in the output unit 31 generates an encryption key, and provides it for the encryption unit 15 and the electronic watermark insertion unit 34.

The encryption unit 15 encrypts the HD contents in the storage unit 19 using an encryption key from the key generation unit 33, and places the HD contents in a non-executable status.

The electronic watermark insertion unit 34 inserts the encryption key from the key generation unit 33 as an electronic watermark into the contents down-converted by the down-conversion unit 13, and outputs the contents to which an electronic watermark is inserted.

On the other hand, the key retrieval unit 35 in the input unit 32 retrieves an encryption key inserted as an electronic watermark into the contents from the ID check unit 16, and provides it for the decryption unit 18.

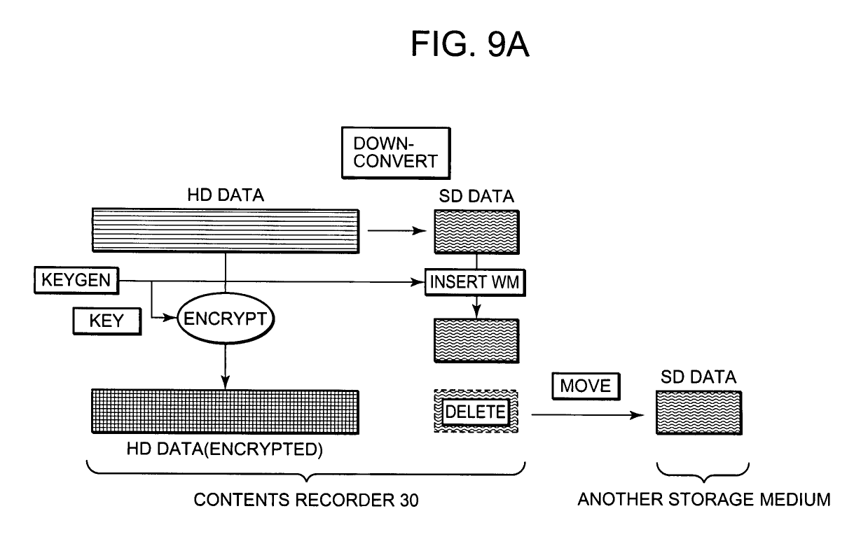

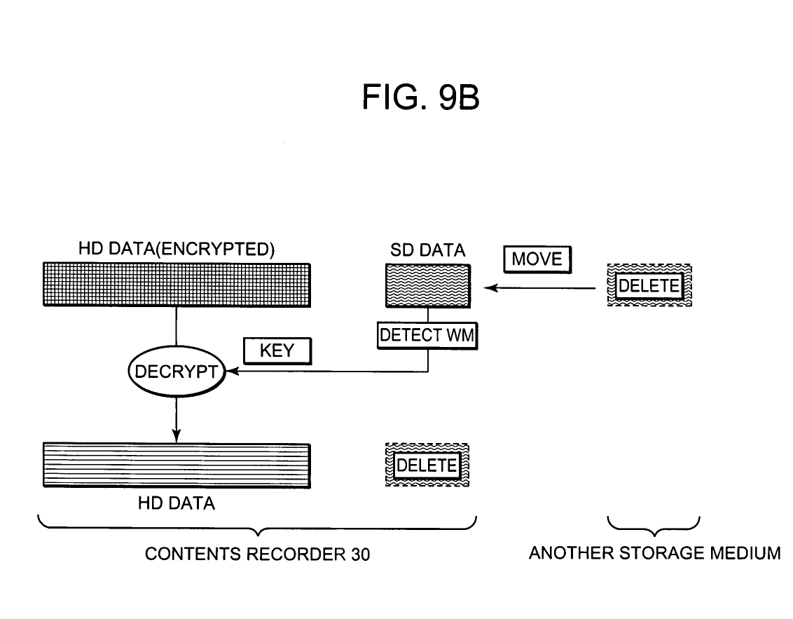

FIG. 9A is a explanation of the operation of “move” from the contents recorder to another storage medium according to the fourth embodiment. With reference to FIG. 9A, HD data is encrypted using a separately generated encryption key. The encryption key is inserted as an electronic watermark (WM as watermark) into the SD data obtained by down-converting the HD data. Thus, the SD data is moved to the other storage medium.

FIG. 9B shows a explanation of the operation of “move” from another storage medium to the contents recorder 30 according to the fourth embodiment. The contents to be moved are the contents of which encrypted data remains in the storage unit 19. With reference to FIG. 9B, when the SD data is moved from the other storage medium to the contents recorder 30, the contents recorder 30 retrieves the encryption key inserted as an electronic watermark into the SD data, and decrypts the encrypted data in the storage unit 19.

As explained above, when contents down-converted by a moving operation and outputted from the contents recorder to another storage medium are moved back, the contents recorder 30 according to the present embodiment can restore the image quality of the contents to the original quality.

Furthermore, according to the present embodiment, an encryption key is inserted into the contents using an electronic watermark technique. Although the contents down-converted in the down-conversion unit 13 is further down-converted, the information about the electronic watermark remains. Therefore, although the contents outputted from the contents recorder 30 is further down-converted and moved to the storage unit 19, the contents recorder 30 can decrypt the contents in the original quality left in the storage unit 19.

Note that a program stored in a record medium, such as unillustrated ROM (read only memory), which exists in the contents recorder, may cause an unillustrated computer to execute the operation of output unit 11 and input unit 12 described above.

What is claimed is:

1. A contents recorder, comprising:
an output unit configured to i) perform a first conversion of converting a first contents stored in a storage unit to an executable second contents and outputting said second contents, and ii) perform a second conversion of converting said first contents in said storage unit to a non-executable third contents and replacing said first contents in said storage unit with said third contents.

2. The contents recorder of claim 1, wherein,
said output unit configured to provide in said first conversion a control element that controls the second conversion.

3. The contents recorder of claim 2, wherein,
said output unit configured to take said control element from said second contents in said first conversion, and encrypt said first contents using said control element as an encryption key in said second conversion.

4. The contents recorder of claim 2, wherein,
said output unit configured to generate said control element based on said second contents in said first conversion, and encrypt said first contents using said control element as an encryption key in said second conversion.

5. The contents recorder of claim 2, wherein,
said output unit configured to take a portion of said first contents as said control element and insert said control element to said second contents in said first conversion, and omit said control element from said first contents in said second conversion.

6. The contents recorder of claim 2, wherein,
said output unit configured to generate said control element and insert said control element to said second contents in said first conversion, and encrypt said first contents using said control element as an encryption key in said second conversion.

7. The contents recorder of claim 2, further comprising:
an input unit configured to input said second contents and reconstruct said first contents in said storage unit from said inputted second contents and said third contents in said storage unit wherein said first contents in said storage unit is restored in an original condition.

8. A contents recording method, comprising:
i) performing a first conversion of converting a first contents stored in a storage unit to an executable second contents and outputting said second contents, and
ii) performing a second conversion of converting said first contents in said storage unit to a non-executable third contents and replacing said first contents in said storage unit with said third contents.

9. The contents recording method of claim 8, wherein,
providing in said first conversion a control element that controls the second conversion.

10. The contents recording method of claim 9, wherein,
taking said control element from said second contents in said first conversion, and encrypting said first contents using said control element as an encryption key in said second conversion.

11. The contents recording method of claim 9, wherein,
generating said control element based on said second contents in said first conversion, and encrypting said first contents using said control element as an encryption key in said second conversion.

12. The contents recording method of claim 9, wherein,
taking a portion of said first contents as said control element and insert said control element to said second contents in said first conversion, and omitting said control element from said first contents in said second conversion.

13. The contents recording method of claim 9, wherein,
generating said control element and insert said control element to said second contents in said first conversion, and encrypting said first contents using said control element as an encryption key in said second conversion.

14. The contents recording method of claim 9, further comprising:
inputting said second contents and reconstructing said first contents in said storage unit from said inputted second contents and said third contents in said storage unit wherein said first contents in said storage unit is restored in an original condition.

15. A computer readable medium storing thereon a control program enabling a computer to execute the contents recording method according to claim 8.

16. A computer readable medium storing thereon a control program enabling a computer to execute the contents recording method according to claim 9.

17. A computer readable medium storing thereon a control program enabling a computer to execute the contents recording method according to claim 10.

18. A computer readable medium storing thereon a control program enabling a computer to execute the contents recording method according to claim 11.

19. A computer readable medium storing thereon a control program enabling a computer to execute the contents recording method according to claim 12.

20. A computer readable medium storing thereon a control program enabling a computer to execute the contents recording method according to claim 14.
